(19) United States
(12) Patent Application Publication
(10) Pub. No.: US 2005/0168693 A1
(43) Pub. Date: Aug. 4, 2005

(54) Method and system for distributing digital cinema events

(76) Inventors: Richard Anthony Mizer, San Francisco, CA (US); Robert John Stewart, San Jose, CA (US); Joe Thomas Malugen, Alford, FL (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/001,820

(22) Filed: Dec. 1, 2004

Related U.S. Application Data
(60) Provisional application No. 60/526,084, filed on Dec. 2, 2003.

(51) Int. Cl. G03B 21/32

(52) U.S. Cl. 352/40

(57) ABSTRACT

Digital Cinema events are streamed under control of a management hub such that audio/video content from content sources is distributed to theatre venues across a wide area, fiber optic network overlaid on a public switched telephone network, which overlay network includes a back channel adapted for transporting signals indicative of user interaction with at least some of the audio/video content, so as to deliver the audio/video content to media gateways resident at each of the theatre venues where it is converted from a first format in which the audio/video content was streamed to one or more second formats adapted for exhibition via respective ones of the theatres' digital projection systems.

### RELATED APPLICATION

This application is related to, incorporates by reference and hereby claims the priority benefit of U.S. Provisional Patent Application No. 60/526,084, filed Dec. 2, 2004.

### FIELD OF THE INVENTION

The present invention relates to methods and systems for transmitting and exhibiting Digital Cinema events, including but not limited to live event audio/video information, digital motion pictures and interactive gaming.

### BACKGROUND

For more than ten years, the entertainment industry has been pursuing a vision known as Digital Cinema. Although the meaning of this term has changed somewhat over the years, most would agree that it is a shorthand way of referring to various complementary technologies that allows for the storage, transmission and projection (or other exhibition) of films in digital format. Experimental deployments of Digital Cinema technology have included Pacific Bell's 1992 development of the Advanced Broadcast Video Service (ABVS), which allowed for non real-time transmission of compressed digital movies via telephone networks for local theatre storage and subsequent exhibition. According to the July 1993 edition of TV Technology (a trade magazine for the broadcast, production, post-production, corporate and cable industries), in a demonstration of the ABVS system earlier that year both NTSC and HDTV content was transmitted from Pac Bell's headquarters in San Francisco to a meeting of the National Association of Broadcasters in Las Vegas.

The ABVS system was intended to operate over a fiber optic network with appropriate codecs at both the transmitting and receiving stations. By March 1994, several public trials and demonstrations of the ABVS system had occurred and the technology was becoming so ubiquitous that explanations of how the system worked even appeared in regular daily newspapers (see, e.g., the Mar. 21, 1994 edition of the Los Angeles Times). In brief, a movie was first transformed from its original film media into digital content and the newly digital movie was compressed for transfer across the fiber optic phone network to a central server where it was stored for later playback. On command, the stored copy of the movie was again transmitted across the fiber optic network (using, for example, ATM cell switching technology) to a number of movie theatres. At each theatre, the compressed digital information was decompressed and then projected on a screen using the theatres' high-definition projectors.

The LA Times article suggests that the ABVS technology could be used to allow different theatres to screen different versions (e.g., a PG version and an R-rated version) of the same movie to different audiences at the same time or different times. Alternatively, different screenings could be presented with alternate endings to gauge audience reactions and acceptance. In one variant of the system, the movies are not downloaded to the various theatres but rather are “streamed” across the fiber optic network for showing in real time.

Another example of Digital Cinema technology is discussed in U.S. Pat. No. 5,924,013. This patent describes a system in which cinematic information including cinemagraphic video images and corresponding audio data are converted into a digital format and RF transmitted from a central site to a movie theater. The digital data received at the movie theater is provided to a digital projector that projects sequential frames of cinemagraphic video data onto a screen. The corresponding audio data is converted into audible sounds sequentially with the projection of each frame of cinemagraphic video images. Orders for cinematic information may be placed via a communication network.

Karen Mills discussed similar Digital Cinema systems in a 1995 article for Millimeter magazine. See, Karen Mills, “You Can't Always Get What You Want: But Mixing and Matching Video Storage Devices You Can Get What You Need”, Millimeter, pp. a5-a13, June 1995. In these systems, digital versions of movies were transferred (via an ATM service) to large storage devices and editors then created different versions of the movies for different formats (e.g., VHS sales, cable television, pay-per-view distributions, etc.). Ms. Mills recognized what others in the industry had also comment on, namely that before Digital Cinema would be widely adopted by studios and filmmakers; security needs would have to be addressed. That is, because the existing Digital Cinema systems tended to produce many copies of the audio/video content that resided outside the control of the studio or distributor, they leaded themselves to piracy or other unauthorized use.

Perhaps for this reason then although Digital Cinema technology has been available since 1992, to date it is conventional film stock that is still used exclusively in the vast majority of theatres around the world. Indeed, even if the security issues could be readily addressed the widespread adoption of Digital Cinema technology would still face obstacles, among them the cost of implementing such systems. Although it is expected that the film industry as a whole may benefit from substantial cost savings if and when Digital Cinema becomes widely available, most of those savings will be realized by film makes and distributors. Theater owners, on the other hand, will be forced to fund the cost of expensive new digital projection systems. With ticket prices already at levels many consumers are unwilling to pay, these owners cannot realistically expect to fund the purchase of such system through increased ticket sales (much of the revenue from which must be paid to the film distributors anyway). Instead, theatre owners will need to look elsewhere for revenue sources to fund these activities.

Exhibition of alternative content, including sporting events, concerts, and interactive games, provides such a vehicle for theatre owners to recoup investments in Digital Cinema technology. Today, although some large-scale installations exist, interactive gaming is mostly limited to networked gaming consoles operated by home-based users. Typically, such uses have access only to limited bandwidth (e.g., as provided by dial-up modems or ADSL lines) and so functionality of these multi-player games is limited. By expanding such events to theatre-based operations, the cost of higher bandwidth communications links could be shared among users, thereby making them more attractive.

Several proposals for the use of theatre networks to host multi-participant interactive events exist in the literature. For example, U.S. Pat. No. 5,801,754 describes an interactive theater network system that links a number of motion picture theater auditoriums so that live, interactive events can be conducted with theater audiences throughout the theater network. An origination site broadcasts information relating to the interactive event, and a plurality of networked theater auditoriums are interactively linked with the origination site. Each network theater includes a full-motion picture projection system configured to receive the interactive event information from the origination site and present the information to the theater audiences. The interactive event information is transmitted from the origination site to the plurality of network theaters with a broadcast communication system. An audience response system provides interactive communication between the origination site and audience members from the network theaters. As part of the audience response system, a data collection system collects and processes data relating to the interactive event that is generated from the audience members. An interactive communication system also provides audio and video communications during the interactive event between audience members across the network and the origination site. Thus, the “means” contemplated in this patent relate to video cameras and the like that communicate video information regarding the audiences between theatres.

Of course, multi-player games need not necessarily involve the networking of different theatres, as exemplified in U.S. Pat. Nos. 6,257,982 and 6,346,045. These patents describe a system for providing video game control stations at the seats of a motion picture theatre or similar entertainment facility such that the members of the audience may, from their seats, participate in a multiple user video game which is displayed on a large screen visible to all. This scenario allows for a large number of simultaneous multiple users to share the same game experience together, and it allows them to share the reactions of each other as the game is played.

Further, U.S. Pat. Nos. 5,835,715 and 6,356,939 describe yet another form of alternative use for theatre operators, namely teaching environments. More particularly, these patents describe an apparatus for interactively presenting information simultaneously in multiple formats to an audience. The system includes a main server connected to a slave server, a video projector and laser disc unit connected to the slayer server, and a number of seat computers connected through an audience response server to the main server. Each seat computer generates category selection signals and topic selection signals upon actuation by an associated audience member and displays the stored information to the associated audience member. The main server is responsive to the category selection signals for controlling the video projector to display stored information related to the topic/category choice on a screen visible to the audience.

Thus, several proposals for alternative uses of theatres by which owners thereof might recoup the costs of implementing Digital Cinema technology have been advanced. Nevertheless such deployments remain limited, indicating that theatre owners have not been convinced that these proposals will see much return on investment. What is needed therefore is a new solution which can help ensure theatre owners and others that the investment in Digital Cinema technology is worthwhile.

### SUMMARY OF THE INVENTION

In an embodiment of the present invention, Digital Cinema events are streamed under control of a management hub such that audio/video content from content sources is distributed to theatre venues across a wide area, fiber optic network overlaid on a public switched telephone network, which overlay network includes a back channel adapted for transporting signals indicative of user interaction with at least some of the audio/video content, so as to deliver the audio/video content to media gateways resident at each of the theatre venues where it is converted from a first format in which the audio/video content was streamed to one or more second formats adapted for exhibition via respective ones of the theatres' digital projection systems.

### BRIEF DESCRIPTION OF THE DRAWINGS

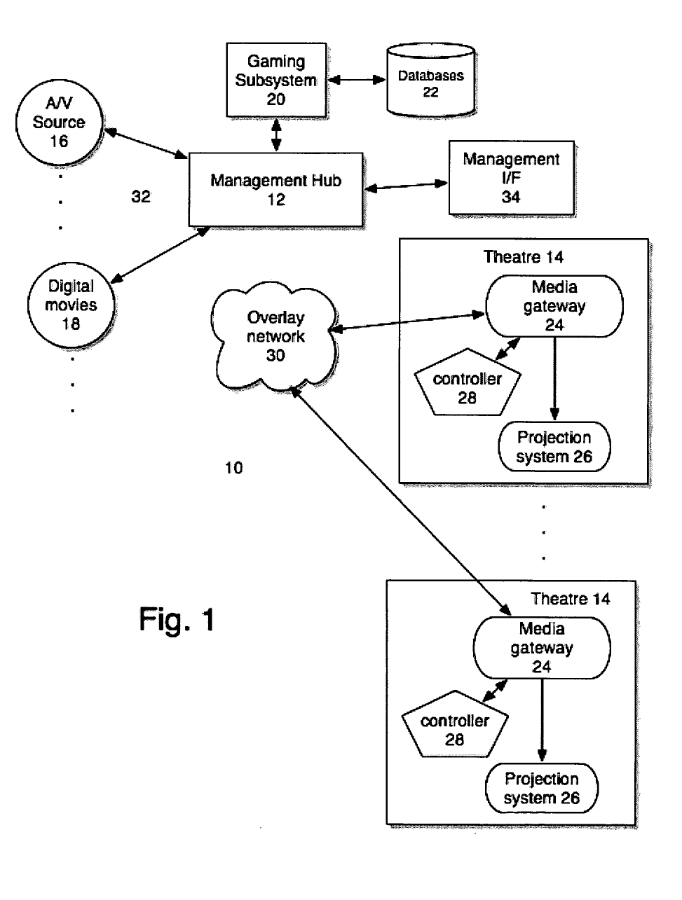

The present invention is illustrated by way of example, and not limitation, in the accompanying FIG. 1, which illustrates a Cinema Events Network configured in accordance with an embodiment of the present invention.

### DETAILED DESCRIPTION

Described herein are methods and systems for distributing Digital Cinema events. The present invention permits the capture, distribution and exhibition of live audio/video content and digital motion picture content by distributors and/or exhibitors (also referred to herein as theatre owners) so that either type of content may be transmitted over a wide area network for delivery to a common theatre projection system. The present invention also permits the use of theatres as interactive gaming venues.

Briefly, the present invention proposes the interconnection of movie theatres with distribution points via fiber optic networks to create a Cinema Events Network. Various types of applications may be distributed via the Cinema Events Network: interactive games, live sports and concerts, and Digital Cinema and advertising. In each case, the content is provided as digital media to be transported across the fiber optic network and presented using digital audio and video equipment at the theatres. Although the description of the present invention provided herein makes reference to various illustrated embodiments of the invention, the invention should not be limited thereby. Instead, the invention should only be measured in terms of the claims that follow this description.

Referring now to FIG. 1, a Cinema Events Network 10 configured in accordance with an embodiment of the invention is illustrated. Cinema Events Network 10 may be regarded as an integrated audio/video transmission system for end-to-end, near real-time transmission of various types of audio/video content to theatre exhibition systems. Also included is a back channel from one or more theatre systems for interactive game applications. Central to the operation of Cinema Events Network 10 is a management hub 12, which coordinates the distribution of the audio/video content to one or more theaters 14. The audio/video content may include live (or delayed) feeds from audio/video equipment 16 located at various events (e.g., sporting events, concerts, new events, etc.); digital movies 18 (e.g., from one or more distributors thereof); and/or interactive games from a gaming subsystem 20 having one or more databases 22.

Within each theater 14 are one or more a media gateways 24 that comprise the means for distributing the different audio/video content within each theatre, for example to various audio/video projection systems 26. Where necessary, the media gateways may be configured to perform protocol conversions so as to convert the digital audio/video information received from management hub 12 to a format compatible with the in-theatre projection systems 26. Media gateways 24 may also interoperate with gaming consoles 28 (such as game consoles available at theatre seats for use by audience members participating in interactive gaming sessions) so as to transfer instructions from users thereof (e.g., movements of a joystick or other control device, etc.) to the gaming subsystem 20, via the management hub 12.

Communicatively connecting the media gateways 24 with the management hub 12 is an overlay network 30 deployed over high bandwidth fiber optic communication links of the public switched telephone network (PSTN). Interconnection in this fashion provides a hub-and-spoke communication architecture between the management hub 12 and the media gateways 24 deployed at theatres 14. In some cases, multiple management hubs (potentially arranged in a hierarchical fashion) may be used, or different management hubs may be deployed in connection with different theatres in different geographic or logically arranged areas.

By provisioning an overlay fiber optic network architecture such as described herein, the present invention provides means for resolving latency, which has been a long-time industry roadblock for introduction of wide area network interactive applications. To appreciate this advantage, consider that conventional moving picture images are typically introduced to the eye at speeds exceeding 24 frames per second (because the eye can generally discern individual frames when played at slower speeds). Live, real-time transmission of such numbers of frames over wide area distances, especially high definition frames with very large numbers of pixels per frame, requires large amounts of dedicated bandwidth. To transmit such information in such manner and then allow a far end user to respond for reverse transmission to the originating or other networked node(s) (e.g., as is the case for interactive gaming) such that the originating viewer sees and hears the response in near real time (e.g., with no appreciable or undesirable audible or visible delay) requires the round-trip interaction to have a measured delay of 250 milliseconds or less. The overlay fiber optic network architecture as described herein enables a measured delay of preferably less than 150 milliseconds for networks whose end nodes are up to 3000 miles apart. Such a minimal delay helps accommodate entertainment industry concerns regarding the introduction interactive audio/video applications to movie theatres. Such a network is therefore ideal for large screen movie theatre applications such as interactive gaming in high definition video.

As will be appreciated, the architecture of Cinema Events network 10 illustrated in FIG. 1 is adapted for distribution of streaming content (other than the interactive gaming content). This may be especially attractive for the motion picture industry because it helps to reduce the risk of piracy. That is, because copies of the movies and other content are not stored (at least for long terms in an entire file format) in Cinema Events Network 10, there is a reduced risk that unauthorized persons will be able to unlawfully copy such content. Of course, in other embodiments such network storage capability may be introduced to Cinema Events network 10 (e.g., at the management hub 12, media gateways 24, or other sites) in order to preserve copies of digital audio/video content for later playback via the theatre projection systems 26. In such cases, appropriate encryption or other digital rights management techniques may be employed so as to reduce the risk of piracy.

In order to accommodate the high bandwidth nature of the content being transported in Cinema Events Network 10, appropriate encoders and decoders may be used to compress the content prior to transport to/from the management hub 12. Although such equipment is not illustrated in detail in FIG. 1, the use of such facilities is well known in the art. For example, satellite and digital cable television distribution systems employ MPEG 2 and MPEG 4 encoding/decoding systems at transmitting and reception stations (e.g., television set-top boxes). Hence, the implementation of such systems is believed to be well known in the art and will not be described further herein so as not to unnecessarily obscure the aspects of the present invention.

Also, the high bandwidth communication links 32 via which the management hub 12 received incoming digital content are illustrated as dedicated links to the audio/video sources. While in some cases such dedicated links may be used, in other (perhaps more common) implementations one or more existing networks or virtual private networks may be used to so distribute the content. For example, in some cases, the overlay network 30, or portions thereof, may be used to distribute the content from the various sources to management hub 12. In other implementations, virtual private networks that make use of Internet backbones or other high bandwidth communication links may be used.

To provide proper interfaces for the overlay network 30, media gateways 24 include fiber optic input and output paths from and to PSTN local loops. The media gateway outputs may include optional or dual feeds to associated storage devices 36 for time-delayed projection and to the projector systems 26 for real-time projection. One of the functions of the media gateway 24 and/or management hub 12 is to deliver content, regardless of its source, in a format that can be used by the theatre projection systems 26. For filmmakers, studios, and the public to embrace the opportunity offered by the present invention, the projection of the moving images onto the large screens must be accomplished in such a fashion that it equals or betters the subjective quality of today's films and television. Because the present invention makes use of multiple different content sources, each having different native formats, protocol converters deployed either at the management hub or at the media gateways will be required to convert from those native formats to a format compatible with the projection systems. Likewise, such conversions may be needed in the case of live event broadcasts which may make use of communications systems having different communication protocols than those used for other content sources.

The management hub 12 is a computer-based deice that enables (under appropriate software control) a network manager to access and control the transmission and distribution of audio/video content from the hub 12 to associated theatres 14. Access to the management hub 12 may be via a local or remote control (e.g., via secure Internet connection) through management interface 34. Preferably, management interface 34 is implemented as a graphical user interface, but one or more command line interfaces may also be used. Where a graphical interface is used, each local loop leg of the overlay network 30 may be illustrated as a icon and the content to be transferred thereover likewise so displayed. Using a series of click and drag (or similar cursor control) operations then, the network manager can easily and quickly designate the type of content to be distributed to one or more destination(s). Such designations may be made in advance of actual transmission times so as to queue up a broadcast plan in advance of the actual distribution. Likewise, through the management interface 34 the operator can designate content to be stored at one or more storage locations for later playback and can also terminate transmissions once they have been completed or upon demand.

In some cases, Cinema Events Network 10 may include centralized network storage, whereby only one copy of digital content exists for access and broadcast to multiple sites. Thus, the present invention resolves long-time entertainment industry security concerns, maintaining control of valuable content in the hands of the studios and distributors.

The present invention allows disparate parties (e.g., filmmakers, distributors, theatre owners, etc.) with different interests and perspectives to work together towards a common objective. Using the Cinema Events Network 10 and a revenue sharing plan described below, each party shares the risk of underwriting the cost of deploying such a network but also shares in the reward produced thereby. Participants in such a business include a facilitator, content owners and producers, network carriers, promoters, and theatre owners.

The facilitator takes the initial risk by investing in the creation of the Cinema Events Network 10. This includes developing a network infrastructure that interconnects selected movie theatres 14 with fiber optic-based communication media at the local loop level. For the most part, such high bandwidth communication links have not yet been deployed to theatres and so this installed base of communications capability will need to be created. Likewise, those theatre owners who have not yet deployed digital projection systems will need to do so, so as to take advantage of the digital content offered over the Cinema Events Network. Contractual arrangements between the facilitator and the theatre owners for fiber interconnection with theatre projection systems and ticket-based revenue sharing for alternative content exhibition will need to be reached. In one embodiment of the invention, the interconnection is provided at no additional cost, meaning that the facilitator bears the cost of the fiber build out and coupling to the theatre systems while the theater owner bears the cost of installing the media gateway and digital projection system.

In addition, the facilitator will need to develop facilities for centralized management and storage (e.g., management hub 12) and build-out of local loop fiber optic interconnects to each theatre 14. This also includes securing the appropriate bandwidth for uploading content from the content sources (e.g., through contractual arrangements with existing carriers or network providers).

The facilitator must also acquire the programming (and preferably exclusive) rights for presentation of live audio/video content. Such content includes major sporting events, concerts events, public interest events, made-for-theatre events, etc. Remote theatre viewing represents a relatively new mode of entertainment (somewhat akin to closed circuit television but on a larger scale) and so some promotion capital will likely need to be invested to educate the public as to the opportunity to view this content. In connection with existing digital content (e.g., movies) the facilitator will need to negotiate with content owners for movie theatre exhibition rights. Again, the per-ticket revenue sharing arrangement as influenced by the number of available seats is preferred.

An agreement between the facilitator and the movie studios/distributors for use of the network infrastructure, storage, access, and transmission of the content will also be required. The Cinema Events Network 10 will need to be made available at a reasonable margin for the distribution of digital movies. That is, the terms of such a deal will have to be lucrative enough to entice the facilitator to actually build the network.

In the case of live event content the facilitator and the various event producers will need to reach an agreement regarding the revenue sharing. This may include provisioning of high definition digital camera equipment, participation in pre-event end-to-end continuity testing, and video transmission oversight during the event. In one embodiment of the invention, such agreement is tariff bound. In other embodiments, such an agreement is based on a per-ticket revenue sharing arrangement.

Agreements between facilitator and one or more wide area network service providers for use of high bandwidth communication links will be needed. Again, such agreements may be tariff bound or based on per-ticket revenue sharing arrangements. The network carrier remains responsible for maintaining the physical network for use in connection with the audio/video transmissions over Cinema Events Network 10. Such a carrier may have an existing fiber optic-based wide area network with local loop interconnect cross-connect facilities.

Theatre owners may select from among the various content choices assembled by the facilitator and provided by the content owners for exhibition in theatres 14. The business proposition to the theatre owner is that certain live events generate greater customer willingness to pay for seating than other content. The revenue sharing model should permit theatre owners to retain greater per ticket revenue for Cinema Event Network events than is customary for conventional films so as to provide an incentive for theatre owners to install digital projection systems 26 and media gateways 24.

In some cases, promoters may also be involved in event advertising and promotion of ticket sales. Depending on the type of event, the promoter may be the content owner, exhibitor, a third party, or a combination of the three. Fee sharing agreements based on a per-ticket model will likely be the norm for such parties.

Notice that in the above-described process the facilitator acts as a type of broker to establish opportunities for the other participants. Revenue splits are passed through the facilitator to each of the other parties per the revenue sharing or other agreements.

Yet another form of alternative content that may be deployed over Cinema Events Network 10 is interactive gaming. Interactive games and other broadcast response applications include the ability for users to interactively compete in a high-resolution environment that includes surround sound with other gamers over a wide area network in a virtual reality world framed by the specific game software. Generally, the interaction is competitive and entertaining in nature. The present invention now takes such gaming out of the home and puts it into public theatre venues. Players will interact and compete within and between such theatres. In this context, video information such as the positions of game pieces on a game board, etc., will be transmitted to multiple different sites to permit the interactive nature of the game to play out.

For such application, the same overlay network 30, and ion-theater distributions systems as are used for film and live event content may be used. However, rather than having each participant in the game send separate video streams back and forth to each of the other theatres, a central network server (gaming subsystem 20) acts as a hub and multicasts the video in a point-to-multipoint manner to each theatre site 14. The gaming software resides in databases 22 accessible by the gaming subsystem 20, which is communicatively coupled to network hub 12 so as to access the overlay network 30. Theatre participants interact with the gaming subsystem 20 by commands from game controllers 28 that trigger the gaming software to broadcast updated video images, sound and other commands to each of the theatres' projection systems 26. This method minimizes the amount of high bandwidth communication facilities needed helps minimize latency in the overall network. Preferably, Internet protocol communication is used for the gaming application.

Thus methods and systems for distributing Digital Cinema events have been described. Although discussed with reference to particular embodiments, the present invention is not meant to be limited thereby. For example, the present Cinema Events Network enables various types of video streaming, including live events and digital motion picture content, and also provides a back channel for viewer interaction (e.g., in interactive gaming or other scenarios). Live content may include high definition television broadcasts over a securely managed network. The interactive gaming applications permit gamers at multiple public venues (e.g., movie theatres) to be networked together for competitive and other events. Motion picture content includes audio/video files that are transmitted over the network as data streams for subsequent movie theater exhibition. A proposed business model binds certain disparate entertainment industry parties in a common business objective.

In other embodiments, the present invention provides methods and systems which include wide area network fiber optic transmission means to enable time-sensitive delivery of live events, interactive gaming, and motion pictures in digital format for exhibition via a theatre's digital projection system. Such a system may include a) an end-to-end fiber optics transmission network between a video source and a theatre digital projection system; b) a media gateway that facilitates protocol conversion between data formats so that the same physical fiber network and in-theatre projection systems can be used for multiple video exhibition applications; c) wide area network based management of transmission, storage and time sensitive delivery of live and stored audio/video and associated data content to in-theatre projection systems; and d) back channels (which may also run over the fiber optic network) interconnecting various ones of the network sites and a management station so that information from any site can be shared with one or more of the other sites.

It is a characteristic of some embodiments of the present invention that occasional wide area network transmission does not require the network to be turned off and then re-initialized. Rather, the network is always on and available for transmission. Moreover, the network is agnostic to network type and transmission protocol, and it is through the use of media gateways that the network can accommodate various transmission protocols, including but not limited to ATM, DTM, MPLS, and SONET. Such media gateways also permit the physical path of network transmissions to span multiple different protocol types over different legs of the network.

Management of the various nodes of the end-to-end network is achieved through remotely control means relative to the transmission, storage, and protocol interfacing and conversion of both broadcast and return path content, including video and audio streaming and data signaling in a point-to-point and/or point-to-multipoint fashion. Thus, content owners have the option of using the system for storing their content at a centralized network hub or other preferred location, or the content can be transmitted for local theatre storage. In either or both cases, security is enabled via secure virtual private network paths.

In still further embodiments, the present invention provides for integrating live events into the entertainment industry's existing movie distribution model. To this model is added the capability for distributing interactive gaming, to be played remotely by multiple players over a fiber optic-based wide area network such that participants can share the same view of the game environment yet still retain independent opportunities for responses, with each independent response multicast to every other player for their own game turns. Thus, the wide area network may be used for both the distribution of live content (including interactive gaming) and time-sensitive content (including digitized movies) in a way that directs, gateways, and couples the transmission path for in-theatre storage and/or real-time screen projection.

Each of the above-described embodiments should be regarded as merely an illustration of the present invention, which should only be measured in terms of the following claims.

1. A method for distributing Digital Cinema events, comprising streaming, under control of a management hub, audio/video content from content sources to distributed theatre venues across a wide area, fiber optic network overlaid on a public switched telephone network and which includes a back channel adapted for transporting signals indicative of user interaction with at least some of the audio/video content, so as to deliver the audio/video content to media gateways resident at each of the theatre venues, and converting, at the media gateways, the audio/video content from a first format in which the audio/video content was streamed to one or more second formats adapted for exhibition via respective ones of the theatres' digital projection systems.

2. The method of claim 1, further comprising storing at least some of the audio/video content prior to exhibition via at least some of the theatres' digital projection systems.

3. The method of claim 2, wherein the storing is performed at a central network storage location.

4. The method of claim 2, wherein the storing is performed at one or more of the media gateways.

5. The method of claim 1, wherein the audio/video content comprises content captured from one or more live events, digital motion picture content and interactive game content.

6. The method of claim 1, wherein the signals indicative of user interaction with at least some of the audio/video content comprise commands for interactive game software.

7. The method of claim 6, wherein the commands for interactive game software are provided to a gaming subsystem communicatively coupled to the management hub.

8. The method of claim 7, wherein in response to the commands for interactive game software the gaming subsystem generates updated gaming audio/video information and distributes the updated gaming audio/video information to at least some of the media gateways for exhibition at corresponding ones of the theatre venues.

9. The method of claim 5, wherein the audio/video content is delivered to the management hub over communications links other than those used for the wide area, fiber optic network.

10. A system, comprising an end-to-end fiber optic network overlaid on a public switched telephone network and organized to communicatively couple a management hub, adapted for controlling distribution of multiple streams of audio/video content, to a plurality of media gateways deployed at theatre venues, each of the media gateways communicatively coupled to respective ones of theatre digital projection systems at the theatre venues and adapted to convert digital audio/video information received from the management hub in a first protocol format to one or more second protocol formats compatible for exhibition via the theatre digital projection systems, wherein the overlay network includes one ore more back channels interconnecting various ones of the theatre venues to the management hub such that user interaction information from any of the various ones of the theatre venues can be shared with others of the various ones of the theatre venues.

11. The system of claim 10, wherein the multiple streams of audio/video content include content captured from live events, digital motion picture content, and interactive gaming content.

12. The system of claim 11, wherein the content captured from live events includes high definition television broadcasts.

13. The system of claim 11 wherein the user interaction information comprises commands for altering the interactive gaming content so as to control game objects.

14. The system of claim 13, wherein the commands for altering the interactive gaming content are transmitted over one or more of the back channels to a gaming subsystem communicatively coupled to the management hub so as to update interactive game software.

15. The system of claim 10 further comprising means for storing some or all of the audio/video content.

16. The system of claim 15, wherein the means for storing is communicatively coupled to the media gateways.

17. The system of claim 15, wherein the means for storing is deployed at the management hub.
